(19) United States
(12) Patent Application Publication
(10) Pub. No.: US 2026/0065852 A1
(43) Pub. Date: Mar. 5, 2026

(54) DISPLAY DEVICE AND DISPLAY SYSTEM

(71) Applicant: LG DISPLAY CO., LTD., SEOUL (KR)

(72) Inventors: Gyusuk Jung, Paju-si (KR); HeeCheol Kim, Paju-si (KR); Juhoon Jang, Paju-si (KR); Myung-Soo Park, Paju-si (KR); DongYeon Kim, Paju-si (KR); GyoHyun Koo, Paju-si (KR)

(21) Appl. No.: 19/286,798

(22) Filed: Jul. 31, 2025

(30) Foreign Application Priority Data
Sep. 3, 2024 (KR) 10-2024-0119397

(51) Int. Cl. G09G 3/3208

(52) U.S. Cl. CPC G09G 3/3208; G09G 2320/068

(57) ABSTRACT

A display device includes a first housing having therein an accommodation space. The display device further includes a display panel accommodated in the first housing. The display device further includes a second housing provided above the display panel and rotatably coupled to the first housing, and exposing a display area of the display panel when the second housing is coupled to the first housing. The display device further includes an optical system including a first part coupled to the second housing, and a second part positioned below the first part, the optical system configured to change a path of light outputted from the display panel.

### CROSS-REFERENCE TO RELATED APPLICATIONS

Pursuant to 35 U.S.C. § 119 (a), this application claims the benefit of an earlier filing date and right of priority to Korean Patent Application No. 10-2024-0119397 filed on Sep. 3, 2024, in the Korean Intellectual Property Office, the disclosure of which is incorporated herein by reference in its entirety.

### TECHNICAL FIELD

The present specification generally relates to display devices and display systems.

### BACKGROUND

Image display devices, which visually implement various electrical information signals on screens, are key technologies in the information and communication era. The range of applications of image display devices expands beyond computer monitors and TVs to include personal mobile devices.

Various display devices, which are thin in thickness and light in weight and have excellent performance and low power consumption, have been developed. Examples of the display devices may include liquid crystal display devices (LCDs), organic light-emitting display devices (OLEDs), and the like.

Meanwhile, recently, users' demands for realistic images have increased, and stereoscopic image display devices capable of displaying three-dimensional images as well as two-dimensional images have been developed.

### SUMMARY

According to an aspect of the present disclosure, there is provided a display device. The display device may include: a first housing having therein an accommodation space; a display panel accommodated in the first housing; a second housing provided above the display panel and rotatably coupled to the first housing, and exposing a display area of the display panel when the second housing is coupled to the first housing; and an optical system including a first part coupled to the second housing, and a second part positioned below the first part, the optical system configured to change a path of light outputted from the display panel.

According to another aspect of the present disclosure, there is provided a display system. The display system may include: a first housing having therein an accommodation space; a display panel accommodated in the first housing; a second housing provided above the display panel and rotatably coupled to the first housing, and exposing a display area of the display panel when the second housing is coupled to the first housing; an optical system coupled to the second housing and configured to change a path of light outputted from the display panel; a depth camera configured to detect positions of an observer's two eyes; a bezel rotation part configured to rotate the second housing in a preset direction and at a predetermined angle; and a controller configured to control a rotation direction and a rotation angle of the bezel rotation part so that a three-dimensional image, among images outputted from the display panel, is outputted to suit a focal point corresponding to the positions of the observer's two eyes detected by the depth camera.

### BRIEF DESCRIPTION OF DRAWINGS

An object to be achieved by the present specification is to provide a display device capable of providing both a two-dimensional image and a three-dimensional image.

Another object to be achieved by the present specification is to provide a display device capable of suppressing a deterioration in resolution when a two-dimensional image is provided even though a lens array for displaying a three-dimensional image is disposed on a display panel.

Still another object to be achieved by the present specification is to provide a display device capable of minimizing 3D crosstalk in accordance with an observation distance when a three-dimensional image is provided.

Objects of the present disclosure are not limited to the above-mentioned objects, and other objects, which are not mentioned above, can be clearly understood by those skilled in the art from the following descriptions.

Other detailed matters of the exemplary implementations are included in the detailed description and the drawings.

The display device according to the implementation of the present specification may provide both the two-dimensional image and the three-dimensional image by means of the optical system capable of variably changing the optical path.

In addition, the display device according to another implementation of the present specification may adjust a degree of a change in the optical path of the optical system even though the optical system for displaying the three-dimensional image is disposed on the display panel, thereby further providing a high-resolution two-dimensional image.

In addition, the display system according to still another implementation of the present specification may minimize crosstalk when providing a three-dimensional image by adjusting a distance between the optical system and the display panel in accordance with a result of detecting the positions of the observer's two eyes.

The effects according to the present disclosure are not limited to the contents exemplified above, and more various effects are included in the present specification.

The above and other aspects, features and other advantages of the present disclosure will be more clearly understood from the following detailed description taken in conjunction with the accompanying drawings.

FIG. 1 is an exploded perspective view schematically illustrating a display device according to an implementation of the present specification.

FIG. 2 is a block diagram for explaining a display panel according to the implementation of the present specification.

FIG. 3 is an exploded perspective view for explaining an optical system of the display device according to the implementation of the present specification.

FIG. 4A is a cross-sectional view taken along line I-I′ in FIG. 3 when a second housing of the display device according to the implementation of the present specification is positioned at one position.

FIG. 4B is a cross-sectional view taken along line II-II′ in FIG. 3 when the second housing of the display device according to the implementation of the present specification is positioned at one position.

FIG. 5A is a cross-sectional view taken along line I-I′ in FIG. 3 when the second housing of the display device according to the implementation of the present specification is rotated and positioned at another position.

FIG. 5B is a cross-sectional view taken along line II-II′ in FIG. 3 when the second housing of the display device according to the implementation of the present specification is rotated and positioned at another position.

FIG. 6 is an exploded perspective view for explaining an optical system of a display device according to another implementation of the present specification.

FIG. 7A is a cross-sectional view taken along line III-III′ in FIG. 6 when a second housing of the display device according to another implementation of the present specification is positioned at one position.

FIG. 7B is a cross-sectional view taken along line III-III′ in FIG. 6 when the second housing of the display device according to another implementation of the present specification is rotated and positioned at another position.

FIG. 8 is an exploded perspective view for explaining an optical system of a display device according to still another implementation of the present specification.

FIG. 9A is a cross-sectional view taken along line IV-IV′ in FIG. 8 when a second housing of the display device according to still another implementation of the present specification is positioned at one position.

FIG. 9B is a cross-sectional view taken along line IV-IV′ in FIG. 8 when the second housing of the display device according to still another implementation of the present specification is rotated and positioned at another position. and

FIG. 10 is a block diagram for explaining a display system according to yet another implementation of the present specification.

### DETAILED DESCRIPTION

Advantages and characteristics of the present disclosure and a method of achieving the advantages and characteristics will be clear by referring to exemplary implementations described below in detail together with the accompanying drawings. However, the present disclosure is not limited to the exemplary implementations disclosed herein but will be implemented in various forms. The exemplary implementations are provided by way of example only so that those skilled in the art can fully understand the disclosures of the present disclosure and the scope of the present disclosure.

The shapes, sizes, ratios, angles, numbers, and the like illustrated in the accompanying drawings for describing the exemplary implementations of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various implementations of the present disclosure can be partially or entirely adhered to or combined with each other and can be interlocked and operated in technically various ways, and the implementations can be carried out independently of or in association with each other.

Hereinafter, a display device according to exemplary implementations of the present disclosure will be described in detail with reference to accompanying drawings.

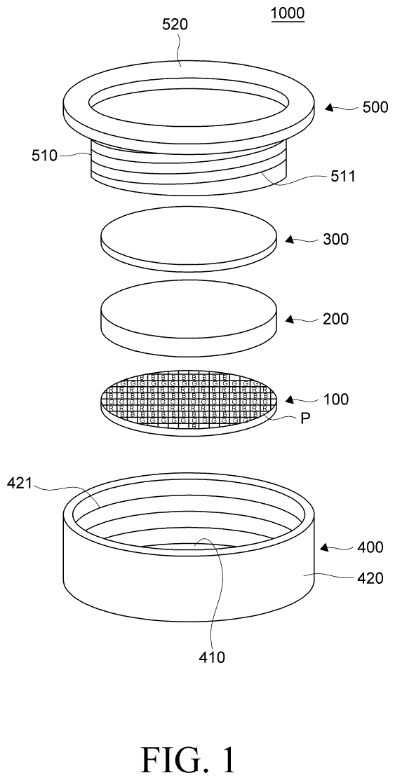

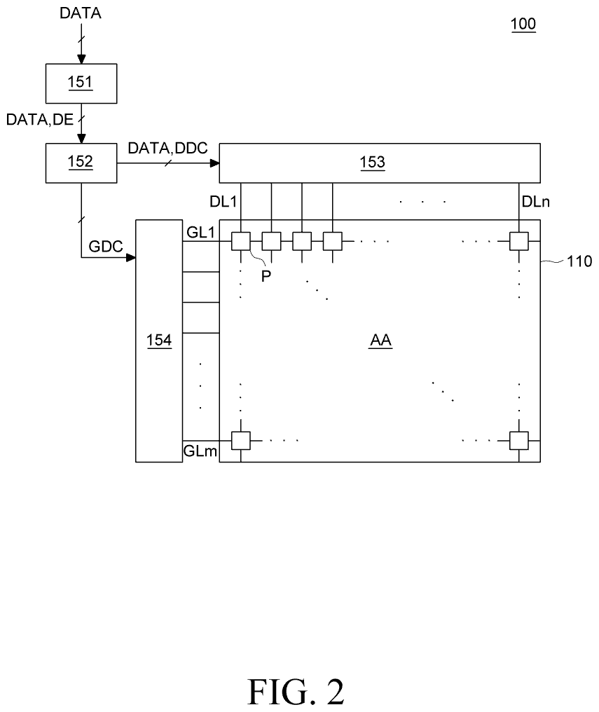

FIG. 1 is an exploded perspective view schematically illustrating a display device according to an implementation of the present specification. FIG. 2 is a block diagram for explaining a display panel according to the implementation of the present specification.

With reference to FIG. 1, a display device 1000 according to an implementation of the present specification may include a display panel 100, a spacer 200, an optical system 300, a first housing 400, and a second housing 500.

The display panel 100 includes a plurality of pixels P and is accommodated and disposed in an internal space of the first housing 400. The display panel 100 according to the implementation of the present specification may output two-dimensional images and three-dimensional images.

With reference to FIG. 2, the display panel 100 may include a substrate 110, an image processor 151, a timing controller 152, a data driver 153, and a gate driver 154.

The display panel 100 is a panel for implementing images. Light-emitting elements for implementing images, circuits for operating the light-emitting elements, lines, components, and the like may be disposed on the substrate 110 of the display panel 100.

The substrate 110 includes a display area AA in which the plurality of pixels P are disposed to display images. A plurality of gate lines GL1 to GLm, which extend in a first direction, and a plurality of data lines DL1 to DLn, which extend in a second direction different from the first direction, may intersect one another and be disposed in the display area AA of the substrate 110. The pixels P are defined at points at which the plurality of gate lines and the plurality of data lines intersect one another on the substrate 110.

One pixel P may include a plurality of subpixels. For example, one pixel P may include three or more subpixels that emit light beams with wavelengths for implementing different colors. In the display panel 100 according to the implementation of the present specification, one pixel P may include the subpixels configured to emit light beams with red (R), green (G), and blue (B) colors. However, the number of subpixels included in one pixel P is not limited thereto. For example, one pixel P may further include a subpixel configured to emit a light beam with a white color in addition to the subpixels configured to emit light beams with red, green, and blue colors. The subpixel may have one or more different light-emitting areas depending on luminous properties.

The subpixels are minimum units that constitute the display area AA. One subpixel may include a light-emitting element, and a drive circuit for operating the light-emitting element. For example, an organic light-emitting element including an anode electrode, an organic light-emitting layer, and a cathode electrode may be disposed in each of the plurality of subpixels. However, the present specification is not limited thereto. For example, in case that the display panel 100 is a liquid crystal display panel, the light-emitting element may be a liquid crystal display element.

FIG. 2 illustrates an example in which the substrate 110 and the display area AA have quadrangular shapes. However, the shapes and the arrangements of the substrate 110 and the display area AA are not limited thereto. That is, the substrate 110 and the display area AA may have shapes suitable for a design of the display device (e.g., the electronic device) having the display panel 100. The substrate 110 and the display area AA may have various exemplary shapes such as pentagonal, hexagonal, circular, and elliptical shapes. The display panel 100 according to the implementation of the present specification will be described with reference to a configuration in which the substrate 110 and the display area AA have circular shapes, as illustrated in FIG. 1.

The plurality of pixels P disposed on the substrate 110 may display images by emitting light in response to a data signal DATA and a scan signal supplied from the data driver 153 and the gate driver 154.

For example, one subpixel includes the organic light-emitting element and the drive circuit. The drive circuit may include a switching transistor, a driving transistor, a capacitor, a gate line, a data line, and lines connected to a power source for operating the pixel. In addition, the drive circuit may further include a compensating circuit.

For example, the subpixel of the display panel 100 according to the implementation of the present specification may have a 2T (transistor) 1C (capacitor) structure including one switching transistor, one driving transistor, and one capacitor.

In this case, one of a source electrode and a drain electrode of the switching transistor may be connected to a first data line DL1, and the other of the source electrode and the drain electrode may be connected to a gate electrode of the driving transistor. One of the source electrode and a drain electrode of the driving transistor may be connected to a line for supplying first power (e.g., a high-potential voltage), and the other of the source electrode and the drain electrode may be connected to one electrode (e.g., the anode electrode) of the organic light-emitting element. One electrode of the capacitor may be connected to the gate electrode of the driving transistor, and the other electrode of the capacitor may be connected to one electrode of the organic light-emitting element. A first electrode (e.g., the anode electrode) of the organic light-emitting element may be connected to the other of the source electrode and the drain electrode of the driving transistor, and a second electrode (e.g., the cathode electrode) of the organic light-emitting element may be connected to a line for supplying second power (e.g., a low-potential voltage). The switching transistor may perform a switching operation so that the data signal DATA, which is supplied through the first data line DL1, is stored in the capacitor as a data voltage in response to a scan signal supplied through a first gate line GL1. In addition, the driving transistor may operate such that a drive current flows between a first power line (e.g., a high-potential voltage line) and a second power line (e.g., a low-potential voltage line) in accordance with the data voltage stored in the capacitor. The organic light-emitting element may operate to emit light in accordance with the drive current produced by the driving transistor.

In addition, the subpixel of the display panel 100 according to the implementation of the present specification may further include a compensating circuit. The compensating circuit refers to a circuit added into the subpixel to compensate for a threshold voltage of the driving transistor or the like. The compensating circuit may include one or more thin-film transistors and a capacitor. For example, the compensating circuit may include a sensing transistor and a sensing line. In this case, the sensing transistor may be connected between one electrode of the driving transistor and one electrode of the organic light-emitting element. The sensing transistor may supply an initialization voltage (or a sensing voltage), which is transmitted through the sensing line, to the connection node between the driving transistor and the organic light-emitting element. The sensing transistor may operate to sense voltages or electric currents of the sensing line or the connection node with the driving transistor.

The compensating circuit may have various configurations depending on an external compensation method. As described above, in case that the compensating circuit is added to the subpixel, the display panel 100 according to the implementation of the present specification may have various structures such as 3T1C, 4T2C, 5T2C, 6T1C, 6T2C, 7T1C, and 7T2C structures.

The image processor 151 may output the data signal DATA, a data enable signal DE, and the like supplied from the outside. In addition, the image processor 151 may output one or more of a vertical synchronizing signal, a horizontal synchronizing signal, and a clock signal in addition to the data enable signal DE. In this case, the image processor 151 may receive the data signal DATA, which is the two-dimensional image information, and the data signal DATA, which is the three-dimensional image information, from the outside.

The timing controller 152 may receive the data signal DATA in addition to the data enable signal DE or the driving signals including the vertical synchronizing signal, the horizontal synchronizing signal, and the clock signal from the image processor 151. In addition, on the basis of the driving signal, the timing controller 152 may output a gate timing control signal GDC for controlling an operation timing of the gate driver 154 and output a data timing control signal DDC for controlling an operation timing of the data driver 153.

In response to the data timing control signal DDC supplied from the timing controller 152, the data driver 153 may sample and latch the data signal DATA supplied from the timing controller 152, convert the data signal DATA into a gamma reference voltage, and output the gamma reference voltage. The data driver 153 may output the data signal DATA through the data lines DL1 to DLn. The data driver 153 may be provided in the form of an integrated circuit (IC).

The gate driver 154 may output the scan signal in response to the gate timing control signal GDC supplied from the timing controller 152. The gate driver 154 may output the scan signal through the gate lines GL1 to GLm. The gate driver 154 may be provided in the form of an integrated circuit (IC) or formed on the display panel DP in a gate-in-panel (GIP) manner.

Meanwhile, the substrate 110 may further include a non-display area configured to surround an outer periphery of the display area AA, and a pad area extending from one side of the non-display area.

The non-display area and the pad area of the substrate 110 are areas in which no image is displayed. Circuits, lines, components, and the like for operating the light-emitting elements in the display area AA may be disposed in the non-display area and the pad area.

For example, various lines, circuits, and the like for receiving external power, signals, and the like may be disposed in the pad area. External modules, e.g., drive ICs, such as the data driver integrated circuit (IC) and the gate driver IC, may be positioned in the pad area. The drive ICs disposed in the pad area may be connected to a plurality of signal lines and connected to the plurality of data lines DL1 to DLn or the plurality of gate lines GL1 to GLm disposed in the display area AA through the plurality of signal lines. That is, the drive ICs disposed in the pad area may be respectively and electrically connected to the plurality of pixels P. Various ICs and various drive circuits may be mounted in the non-display area of the substrate 110 in a gate-in-panel (GIP) manner, a tape-carrier-package (TCP) manner, or a chip-on-film (COF) manner and connected to the display panel 100.

A pad part for receiving signals from the outside may be disposed in the non-display area and the pad area. The pad part may be electrically connected to various signal lines and various circuits connected to the pixel P. The pad part may include a data pad part for transmitting the data signal to the data line, and a gate pad part for transmitting the gate signal to the gate line. However, the present specification is not limited thereto.

The data pad part may be disposed in the pad area provided at one side of the substrate 110. However, the present specification is not limited thereto. The data pad part may be electrically connected to the data driver 153 and supply the data voltage to the plurality of data lines DL1 to DLn. The data driver 153 may receive the image data from the timing controller 152, supply the data voltage to the plurality of data lines DL1 to DLn, and operate the plurality of data lines DL1 to DLn. The data driver 153 may be implemented by including one or more source driver integrated circuits. For example, the source driver integrated circuits may each include a shift register, a latch circuit, a digital-analog converter (DAC), an output buffer, and the like. In some instances, the data driver may further include one or more analog-digital converters (ADC).

The gate pad part may be disposed in the non-display area provided at another side of the substrate 110 at which the data pad part is not disposed. However, the present specification is not limited thereto. The gate pad part may be electrically connected to the gate driver 154 and supply the scan signals to the plurality of gate lines GL1 to GLm. The gate driver 154 may operate the plurality of gate lines GL1 to GLm by outputting the scan signals to the plurality of gate lines GL1 to GLm. For example, the gate driver 154 may sequentially operate the plurality of gate lines GL1 to GLm by sequentially supplying the scan signals to the plurality of gate lines GL1 to GLm. The gate driver 154 may sequentially supply the scan signals with ON-voltages or OFF-voltages to the plurality of gate lines GL1 to GLm under the control of the timing controller 152. The gate driver 154 may include a plurality of gate drive circuits. In this case, the plurality of gate drive circuits may respectively correspond to the plurality of gate lines GL1 to GLm. For example, the gate drive circuits may each include a shift register, a level shifter, and the like. The gate drive circuits may each be implemented as a gate-in-panel (GIP) type and embedded in the display panel 100. The gate drive circuits may each be disposed directly on the gate pad part.

In addition, a controller electrically connected to the pad part may be mounted and disposed on the printed circuit board in the pad area. For example, the controller may be the timing controller 152. However, the present specification is not limited thereto. The controller may be a control device capable of performing various other control functions together with the timing controller 152. The controller may be implemented as an electronic component or various circuits such as integrated circuits (ICs), field programmable GATE1 arrays (FPGAs), application specific integrated circuits (ASICs), or processors.

With reference to FIG. 1, the spacer 200 may be disposed above the display panel 100 and accommodated in the first housing 400. The spacer 200 serves to ensure an interval required to collect light of a three-dimensional image, which is outputted from the display panel 100, into an observer's two eyes. The spacer 200 is disposed between the display panel 100 and the optical system 300. For example, the spacer 200 may have a predetermined thickness and be made of glass capable of transmitting the light outputted from the display panel 100. However, the present specification is not limited thereto. In addition, the spacer 200 may have a planar shape corresponding to a planar shape of the display panel 100. However, the present specification is not limited thereto.

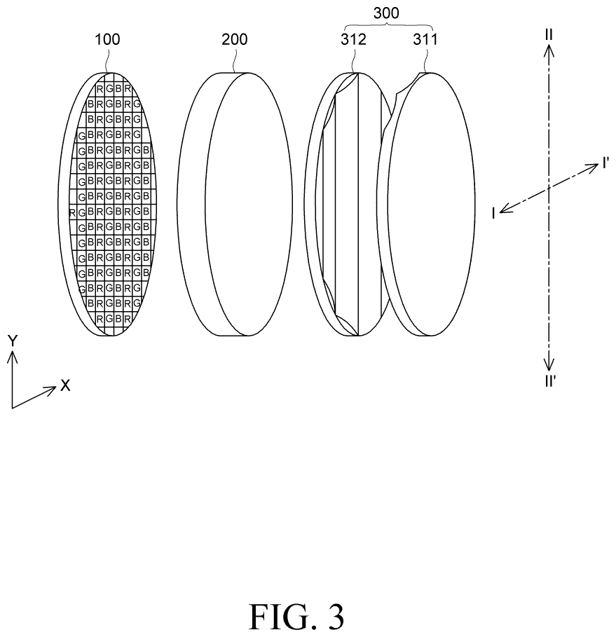

The optical system 300 is positioned above the display panel 100 and changes a path of the light outputted from the display panel 100. The optical system 300 includes a first part coupled to the second housing 500, and a second part positioned below the first part. The first and second parts of the optical system 300 will be described below more specifically with reference to FIGS. 3 to 5B. In addition, the optical system 300 may have a planar shape corresponding to the planar shape of the display panel 100. However, the present specification is not limited thereto.

The first housing 400 has therein an accommodation space in which at least some components of the display panel 100, the spacer 200, and the optical system 300 may be accommodated.

The second housing 500 is disposed above the display panel 100 and rotatably coupled to the first housing 400. The second housing 500 exposes the plurality of pixels P of the display panel 100 when the second housing 500 is coupled to the first housing 400.

For example, in the display device 1000 according to the implementation of the present specification, the first housing 400 and the second housing 500 may be screw-coupled. However, the way in which the second housing 500 is rotatably coupled to the first housing 400 is not limited thereto.

As illustrated in FIG. 1, the second housing 500 includes a bezel 520 including an opening portion through which the display area AA of the display panel 100 is exposed, and a support portion 510 extending from the bezel 520 in a downward direction. In this case, a screw thread 511 may be provided on an outer surface of the support portion 510 of the second housing 500 and screw-coupled to the first housing 400. In addition, the first housing 400 includes a bottom portion 410 having a predetermined area, and a support portion 420 extending from the bottom portion 410 in an upward direction. In this case, a screw trough 421 may be provided in an inner surface of the support portion 420 of the first housing 400 and correspond to the screw thread 511 provided on the outer surface of the support portion 510 of the second housing 500. However, the structure in which the first housing 400 and the second housing 500 are screw-coupled is not limited thereto. For example, a screw thread or screw trough, which is configured to be coupled to the first housing 400, may be provided on the outer or inner surface of the support portion 510 of the second housing 500. In addition, a screw trough, which corresponds to the screw thread of the support portion 510 of the second housing 500, or a screw thread, which corresponds to the screw trough of the support portion 510 of the second housing 500, may be provided on the inner or outer surface of the support portion 420 of the first housing 400.

FIG. 3 is an exploded perspective view for explaining the optical system of the display device according to the implementation of the present specification.

With reference to FIG. 3, a first part 311 of the optical system 300 according to the implementation of the present specification may be a concave lens array layer having a plurality of concave lenses disposed on a surface facing a second part 312, and the second part 312 of the optical system 300 may be a convex lens array layer having a plurality of convex lenses disposed on a surface facing the first part 311. With reference to FIGS. 1 and 3 together, the display panel 100, the spacer 200, and a part of the optical system 300 may be sequentially accommodated in the first housing 400. In this case, the convex lens array layer 312 of the optical system 300 may be disposed on the spacer 200 and accommodated in the first housing 400, and the concave lens array layer 311 may be disposed above the convex lens array layer 312 when the concave lens array layer 311 is coupled to one side of the second housing 500.

For example, the convex lens array layer 312 of the optical system 300 may include a plurality of lenticular lenses each having a predetermined width and a curved portion. The lenticular lenses may implement a three-dimensional image in a preset area by using the light emitted from the display area AA of the display panel 100. For example, the display device 1000 according to the implementation of the present specification may be a light field display (LFD) apparatus in which the light beams emitted from the pixels overlap one another in a set area by the lenticular lenses. In addition, the lenticular lenses may each have a larger diameter than two subpixels. In addition, the lenticular lenses may be made of glass or plastic having a refractive index larger than 1.

The concave lens array layer 311 of the optical system 300 may have a width equal to a width of the lenticular lens of the convex lens array layer 312 and include the concave lenses having the curved portions inversely proportional to the curved portion of the lenticular lens of the convex lens array layer 312. Therefore, the convex lenses of the convex lens array layer 312 and the concave lenses of the concave lens array layer 311 may have focal lengths that are equal in magnitudes but have opposite signs.

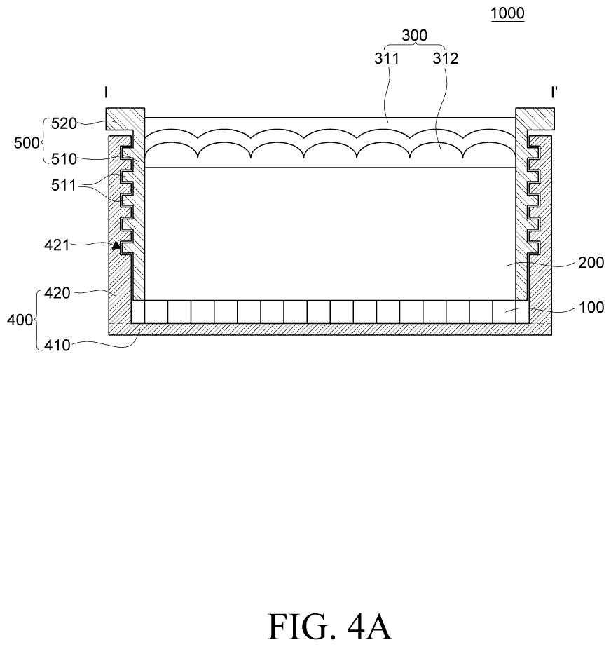

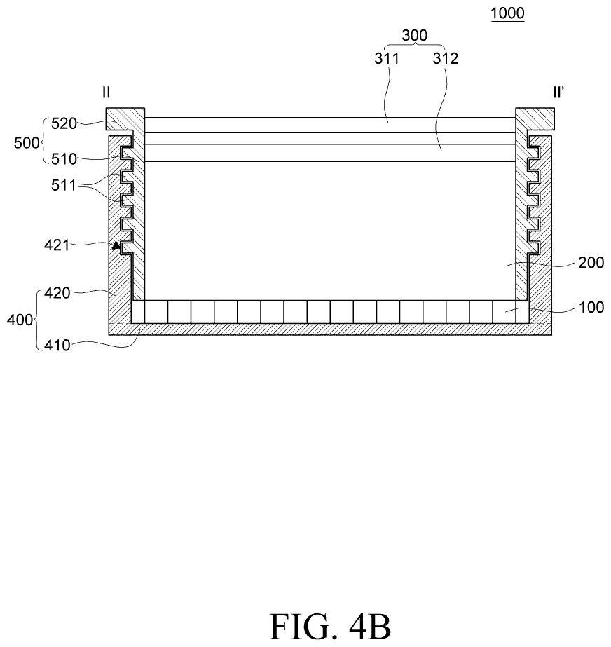

FIG. 4A is a cross-sectional view taken along line I-I′ in FIG. 3 when the second housing of the display device according to the implementation of the present specification is positioned at one position. FIG. 4B is a cross-sectional view taken along line II-II′ in FIG. 3 when the second housing of the display device according to the implementation of the present specification is positioned at one position.

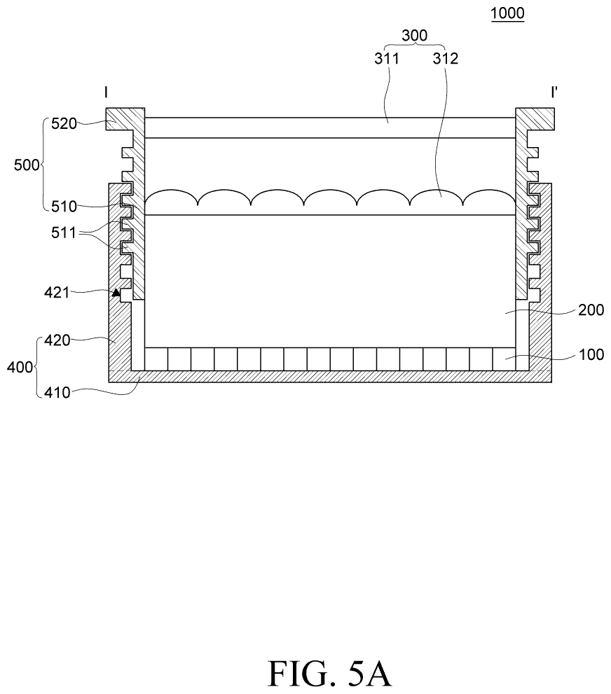

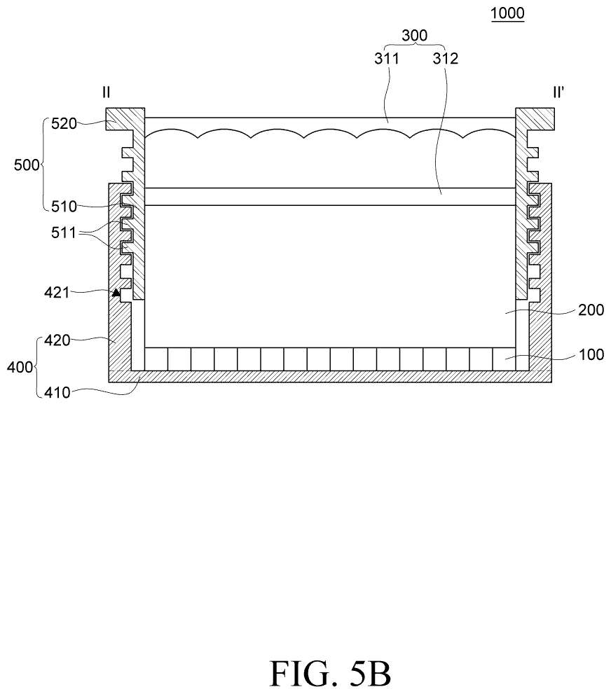

FIG. 5A is a cross-sectional view taken along line I-I′ in FIG. 3 when the second housing of the display device according to the implementation of the present specification is rotated and positioned at another position. FIG. 5B is a cross-sectional view taken along line II-II′ in FIG. 3 when the second housing of the display device according to the implementation of the present specification is rotated and positioned at another position.

With reference to FIGS. 1, 3, and 4A together, the convex lens array layer 312 of the optical system 300 is disposed on the spacer 200 and accommodated in the internal space of the first housing 400. Further, the concave lens array layer 311 of the optical system 300 is coupled to a part of the second housing 500 and rotates together with the second housing 500 when the second housing 500 rotates. FIG. 4A illustrates that an edge of the concave lens array layer 311 is joined inside the bezel 520 of the second housing 500 and joined over an inner upper side of the support portion 510. However, the position at which the concave lens array layer 311 is coupled to the second housing 500 is not limited thereto. For example, the concave lens array layer 311 may be coupled only to the bezel 520. In this case, a top surface of the concave lens array layer 311 may be parallel to a top surface of the bezel 520. In addition, the top surface of the bezel 520 and the top surface of the concave lens array layer 311 may be positioned on the same line or positioned on different lines. In addition, the concave lens array layer 311 may be coupled only to the inner upper portion of the support portion 510. In this case, the top surface of the bezel 520 and the top surface of the concave lens array layer 311 may be parallel to each other. The second housing 500 may rotate at least between a first position at which the plurality of concave lenses included in the concave lens array layer 311 are parallel to the plurality of convex lenses included in the convex lens array layer 312 and a second position at which the plurality of concave lenses included in the concave lens array layer 311 are perpendicular to the plurality of convex lenses included in the convex lens array layer 312.

FIG. 4A illustrates a cross-section taken along a line (I-I′) traversing the display device 1000 in a first direction (e.g., an X-axis direction in FIG. 3) in which the observer's two eyes are positioned in case that the second housing 500 is disposed at the first position.

As illustrated in FIG. 4A, in the first direction (i.e., the X-axis direction), the convex lens array layer 312 has a plurality of convex lens shapes, and the concave lens array layer 311 has a plurality of concave lens shapes. The shape of each of the concave lenses of the concave lens array layer 311 disposed above the convex lens array layer 312 corresponds to the shape of each of the convex lenses of the convex lens array layer 312. In this case, in case that the focal length of the convex lens of the convex lens array layer 312 is “f1=f”, the focal length of the concave lens of the concave lens array layer 311 may be “f2=−f”. Therefore, as illustrated in FIG. 4A, in case that the convex lenses of the convex lens array layer 312 and the concave lenses of the concave lens array layer 311 are parallel to one another, a composite focal point of the convex lens of the convex lens array layer 312 and the concave lens of the concave lens array layer 311 is “0”.

FIG. 4B illustrates a cross-section taken along a line (II-II′) traversing the display device 1000 in a second direction (e.g., a Y-axis direction in FIG. 3) perpendicular to the first direction in case that the second housing 500 is disposed at the first position. As illustrated in FIG. 4B, in the second direction (i.e., the Y-axis direction), the convex lens array layer 312 and the concave lens array layer 311 do not have the convex or concave shapes of the lenses. In this case, the focal length of the convex lens of the convex lens array layer 312 may be “f1=∞”, and the focal length of the concave lens of the concave lens array layer 311 may be “f2=∞”.

Therefore, as illustrated in FIGS. 4A and 4B, when the first housing 400 is disposed at the first position and the concave lenses of the concave lens array layer 311 are parallel to the convex lenses of the convex lens array layer 312, the optical system 300 does not operate as the lenticular lens that displays a three-dimensional image, such that the optical system 300 does not change the path of the light outputted from the display panel 100. In this case, the display panel 100 may output images in accordance with two-dimensional image information.

FIGS. 5A and 5B illustrate that the second housing 500 is rotated by 90° with respect to the first position and disposed at the second position. As the second housing 500 rotates by 90°, the concave lens array layer 311 coupled to the second housing 500 also rotates by 90°.

FIG. 5A illustrates a cross-section taken along the line (I-I′) traversing the display device 1000 in the first direction (e.g., the X-axis direction in FIG. 3) in which the observer's two eyes are positioned in case that the second housing 500 is disposed at the second position.

As illustrated in FIG. 5A, in the first direction (i.e., the X-axis direction), the convex lens array layer 312 has a plurality of convex lens shapes, whereas the concave lens array layer 311 does not form a concave lens shape. Therefore, in case that the focal length of the convex lens of the convex lens array layer 312 is “f1=f”, the focal length of the concave lens of the concave lens array layer 311 may be “f2=∞”. Therefore, as illustrated in FIG. 5A, in case that the convex lenses of the convex lens array layer 312 and the concave lenses of the concave lens array layer 311 are perpendicular to one another, the path of the light outputted from the display panel 100 by the convex lenses of the convex lens array layer 312 is changed to be different from the path of light in case that the second housing 500 is disposed at the first position. That is, the light beams outputted from different pixels of the display panel 100 are refracted in different directions while passing through the same convex lens of the convex lens array layer 312, such that the light beams are collected into the left and right eyes of the observer, such that a three-dimensional image may be implemented.

FIG. 5B illustrates a cross-section taken along the line (II-II′) traversing the display device 1000 in the second direction (e.g., the Y-axis direction in FIG. 3) perpendicular to the first direction in case that the second housing 500 is disposed at the second position. As illustrated in FIG. 5B, in the first direction (i.e., the X-axis direction), the convex lens array layer 312 does not form a convex lens shape, and the concave lens array layer 311 has a concave lens shape. Therefore, in case that the focal length of the convex lens of the convex lens array layer 312 is “f1=∞”, the focal length of the concave lens of the concave lens array layer 311 may be “f2=−f”.

Therefore, as illustrated in FIGS. 5A and 5b, in case that the first housing 400 is disposed at the second position and the concave lenses of the concave lens array layer 311 are perpendicular to the convex lenses of the convex lens array layer 312, the optical system 300 operates as the lenticular lens that displays a three-dimensional image, such that the optical system 300 changes the path of the light outputted from the display panel 100. In this case, the display panel 100 may output images in accordance with three-dimensional image information. That is, because it is as if there is only the convex lens array in the first direction (i.e., the X-axis direction), the light beams outputted from the pixels P of the display panel 100 are refracted in different directions by the convex lenses and collected into the left and right eyes of the observer. Because it is as if there is only the concave lens array in the second direction (i.e., the Y direction), the light beams outputted from the pixels P are merely spread without being separated. As described above, when the second housing 500 is disposed at the second position, the light beams are separated only in the first direction by the optical system 300, such that the display device 1000 may operate as a lenticular LFD and output a three-dimensional image.

Meanwhile, as illustrated in FIGS. 4A to 5B, a predetermined interval is defined between the concave lens array layer 311 and the convex lens array layer 312, and the second housing 500 rotates from the first position to the second position, such that the interval between the concave lens array layer 311 and the convex lens array layer 312 may gradually increase. Therefore, the concave lens array layer 311 is inhibited from being rubbed or caught between the concave lens array layer 311 and the convex lens array layer 312 when the concave lens array layer 311 rotates.

With reference to FIGS. 4A and 4B, when the second housing 500 is disposed at the first position, i.e., when a two-dimensional image is outputted from the display panel 100, a distance between the convex lens array layer 312 and the concave lens array layer 311 may be minimized.

In addition, with reference to FIGS. 5A and 5B, when the second housing 500 is disposed at the second position, i.e., when a three-dimensional image is outputted from the display panel 100, a distance between the convex lens array layer 312 and the concave lens array layer 311 may be maximized. When the second housing 500 is disposed at the second position, the display panel 100 may output a three-dimensional image after various image processing for compensating for the distortion caused by the distance between the convex lens array layer 312 and the concave lens array layer 311 during 3D rendering for three-dimensional image information. In this case, the compensation for the distortion caused by the distance between the convex lens array layer 312 and the concave lens array layer 311 may be processed by the image processor 151 of the display panel 100. However, the present specification is not limited thereto. For example, the data signal DATA inputted to the image processor 151 may be a signal made by compensating for the distortion caused by the distance between the convex lens array layer 312 and the concave lens array layer 311.

Therefore, the display device 1000 according to the implementation of the present specification may provide both the two-dimensional image and the three-dimensional image and suppress a deterioration in resolution when the two-dimensional image is provided even though the lens array for displaying the three-dimensional image is disposed on the display panel 100.

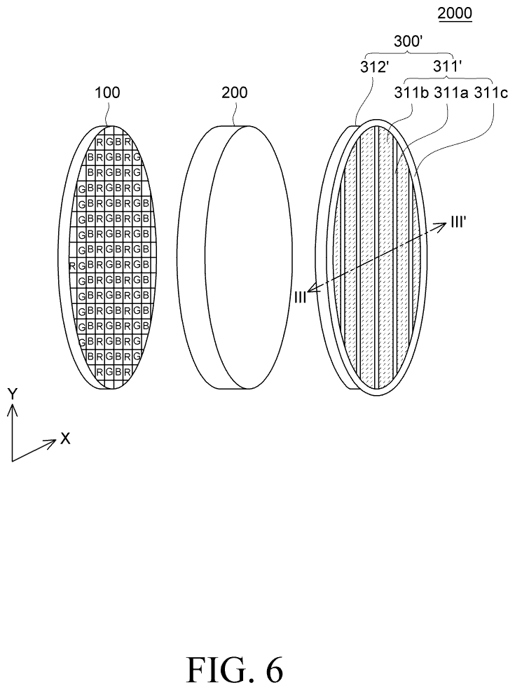

FIG. 6 is an exploded perspective view for explaining some components of the display device according to another implementation of the present specification.

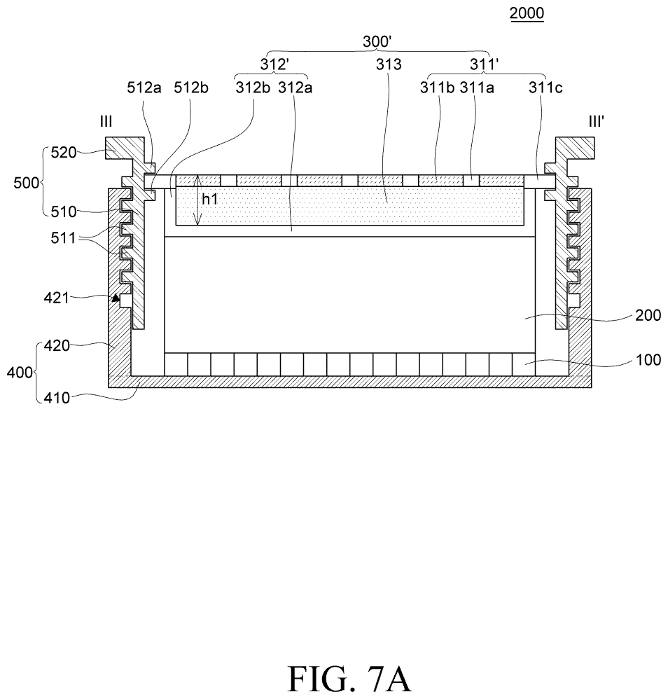

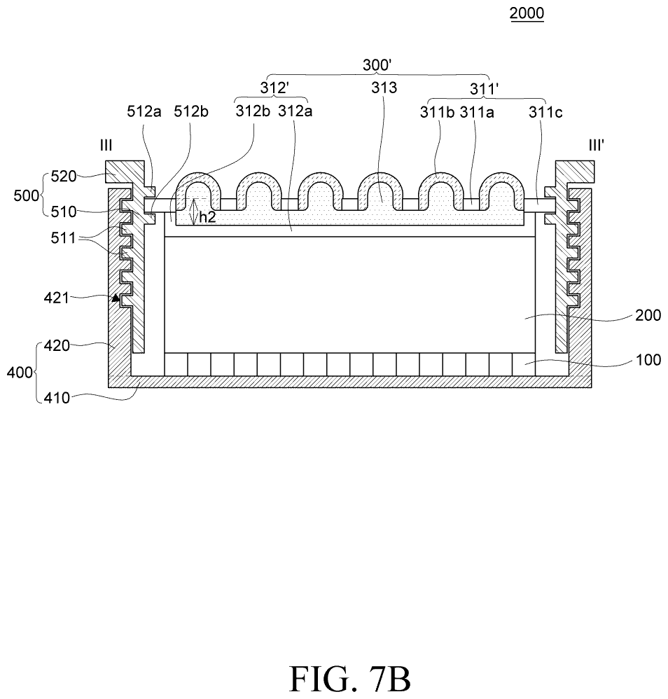

FIG. 7A is a cross-sectional view taken along line III-III′ in FIG. 6 when a second housing of the display device according to another implementation of the present specification is positioned at one position. FIG. 7B is a cross-sectional view taken along line III-III′ in FIG. 6 when the second housing of the display device according to another implementation of the present specification is rotated and positioned at another position.

Because a display device 2000 according to another implementation of the present specification is substantially identical in configurations to the display device 1000 according to the implementation of the present specification described above with reference to FIGS. 1 and 2, except for an optical system 300′ and some components of the second housing 500, a repeated description will be omitted.

With reference to FIGS. 6 and 7A together, the optical system 300′ according to another implementation of the present specification includes a first part 311′ coupled to the second housing 500, and a second part 312′ positioned below the first part 311′.

The first part 311′ of the optical system 300′ may be a lens array layer including a plurality of partition walls 311a spaced apart from one another at predetermined intervals, elastic films 311b disposed between the partition walls 311a, and rim portions 311c joined to two opposite ends of the partition walls 311a and edges of the elastic films 311b.

The second part 312′ of the optical system 300′ may be an elastic body part including a bottom portion 312a having a predetermined area, and a support portion 312b extending upward from an edge of the bottom portion 312a and joined to the edge of the lens array layer 311′. The elastic body part 312′ may include an internal space sealed by joining the elastic body part 312′ and the lens array layer 311′, and a liquid 313 may be accommodated in the sealed internal space of the elastic body part 312′. For example, as illustrated in FIG. 7A, a sealed internal space may be formed by bonding the support portion 312b of the elastic body part 312′ to a part of a bottom surface of the rim portion 311c of the lens array layer 311′.

Either the elastic film 311b, or the elastic body part 312′, or both the elastic film 311b and the elastic body part 312′ of the optical system 300′ may include polydimethylsiloxane (PDMS). In addition, the liquid 313 accommodated in the internal space sealed by the lens array layer 311′ and the elastic body part 312′ may be an ethylene glycol aqueous solution that is not chemically reactive with PDMS.

The elastic body part 312′ of the optical system 300′ may be disposed on the spacer 200 and accommodated in the first housing 400, and the lens array layer 311′ may be disposed above the elastic body part 312′ when the lens array layer 311′ is coupled to one side of the second housing 500.

With reference to FIG. 7A, the support portion 510 of the second housing 500 includes a first coupling protrusion 512a and a second coupling protrusion 512b at an upper inner side thereof, and the first coupling protrusion 512a and the second coupling protrusion 512b are disposed to be spaced apart from each other at a predetermined interval in a vertical direction. A part of the rim portion 311c of the lens array layer 311′ is inserted and coupled into a separation space between the first coupling protrusion 512a and the second coupling protrusion 512b provided on the support portion 510 of the second housing 500. That is, the rim portion 311c of the lens array layer 311′ is caught by the first coupling protrusion 512a and the second coupling protrusion 512b of the support portion 510 of the second housing 500. In addition, at least a part of the bottom portion 312a of the elastic body part 312′ is bonded to the top surface of the spacer 200.

The second housing 500 may rotate at least between a first position at which a surface of the elastic film 311b is parallel to a top surface of the second housing 500 and a second position at which the surface of the elastic film 311b is divided by the plurality of partition walls 311a to define a plurality of convex lens shapes each having a maximum center thickness.

When the second housing 500 rotates between the first position and the second position, the rim portion 311c of the lens array layer 311′, which has the bottom surface to which the support portion 312b of the elastic body part 312′ is bonded, is caught by the first coupling protrusion 512a and the second coupling protrusion 512b provided on the support portion 510 of the second housing 500 and receives a force in an upward/downward direction in the state in which the bottom portion 312a of the elastic body part 312′ is bonded to the spacer 200, such that a height of the support portion 312b of the elastic body part 312′ changes. In addition, when the second housing 500 rotates between the first position and the second position, a distance between the lens array layer 311′ and the display panel 100 also changes.

FIGS. 7A and 7B illustrate that the first and second coupling protrusions 512a and 512b are provided on the inner upper portion of the support portion 510 of the second housing 500, and the rim portion 311c of the lens array layer 311′ is coupled to the upper portion of the support portion 510. However, the position at which the lens array layer 311′ is coupled to the second housing 500 is not limited thereto. For example, the first and second coupling protrusions 512a and 512b of the second housing 500 may be provided inside the bezel 520 or provided inside the bezel 520 and the support portion 510. In addition, the top surface of the lens array layer 311′ may be parallel to the top surface of the bezel 520, and the top surface of the bezel 520 and the top surface of the lens array layer 311′ may be positioned on the same line or positioned different lines.

FIG. 7A illustrates a cross-section taken along a line (III-III′) traversing the display device 2000 in the first direction (e.g., the X-axis direction in FIG. 6) in which the observer's two eyes are positioned in case that the second housing 500 is disposed at the first position.

As illustrated in FIG. 7A, in case that the second housing 500 is positioned at the first position, the surface of the elastic film 311b of the lens array layer 311′ is parallel to the top surface of the partition wall 311a and the bezel 520 of the second housing 500 in the first direction (i.e., the X-axis direction), and thus the lens array layer 311′ does not have a lens shape. Therefore, in case that the second housing 500 is disposed at the first position, the optical system 300′ does not change the path of the light outputted from the display panel 100. In this case, the display panel 100 may output images in accordance with two-dimensional image information.

FIG. 7B illustrates a cross-section taken along a line (III-III′) traversing the display device 2000 in the first direction (e.g., the X-axis direction in FIG. 6) in which the observer's two eyes are positioned in case that the second housing 500 is disposed at the second position.

As illustrated in FIG. 7B, in case that the second housing 500 is disposed at the second position, the surface of the elastic film 311b of the lens array layer 311′ is divided in the first direction (i.e., the X-axis direction) by the partition walls 311a to define a plurality of convex lens shapes each having a maximum center thickness. Therefore, the lens array layer 311′ of the optical system 300′ may include a plurality of lenticular lenses each having a predetermined width and a curved portion. The lenticular lenses may implement a three-dimensional image in a preset area by using the light emitted from the display area AA of the display panel 100. For example, the display device 2000 according to another implementation of the present specification may be the LFD in the state in which the second housing 500 is disposed at the second position. In addition, the lenticular lenses may each have a larger diameter than two subpixels.

A distance h2 between the lens array layer 311′ and the bottom portion 312a of the elastic body part 312′ when the second housing 500 is disposed at the second position is smaller than a distance h1 between the lens array layer 311′ and the bottom portion 312a of the elastic body part 312′ when the second housing 500 is disposed at the first position. That is, a height of the support portion 312b of the elastic body part 312′ decreases. Therefore, hydraulic pressure is applied in the upward direction to the elastic film 311b by the liquid 313 accommodated in the internal space of the elastic body part 312′, such that the convex lens shape having a predetermined curved portion changes from the portion where the elastic film 311b is bonded to the partition walls 311a at two opposite sides. Therefore, the optical system 300′ operates as the lenticular lens for displaying a three-dimensional image, and the optical system 300′ changes the path of the light outputted from the display panel 100. In this case, the display panel 100 may output images in accordance with three-dimensional image information. That is, the light beams outputted from different pixels of the display panel 100 are refracted in different directions while passing through the same convex lens of the lens array layer 311′, such that the light beams are collected into the left and right eyes of the observer, such that a three-dimensional image may be implemented.

In addition, as the second housing 500 rotates from the first position to the second position, the center thicknesses of the plurality of convex lenses of the lens array layer 311′ gradually increase, and the distance between the top surface of the second housing 500 and the display panel 100 gradually decreases.

Meanwhile, FIGS. 6 to 7B illustrate that the optical system 300′ according to another implementation of the present specification is the hydraulic lenticular lens array. However, the present specification is not limited thereto. For example, the optical system 300′ may be a pneumatic lenticular lens array. In this case, the sealed internal space of the elastic body part 312′ may be filled with air.

Therefore, the display device 2000 according to another implementation of the present specification may provide both the two-dimensional image and the three-dimensional image and suppress a deterioration in resolution when the two-dimensional image is provided even though the lens array for displaying the three-dimensional image is disposed on the display panel 100.

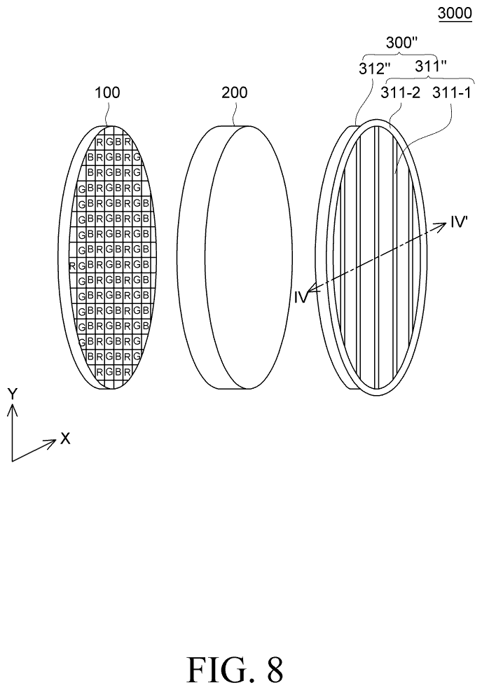

FIG. 8 is an exploded perspective view for explaining some components of the display device according to still another implementation of the present specification.

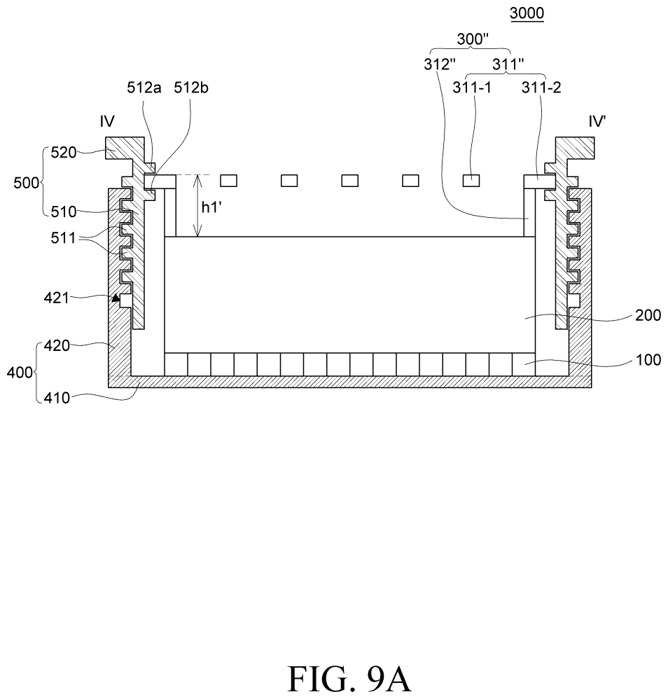

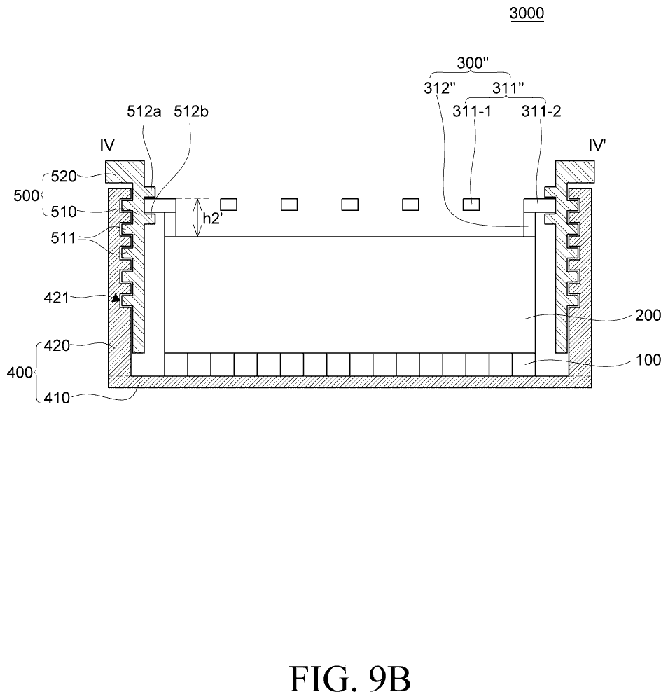

FIG. 9A is a cross-sectional view taken along line IV-IV′ in FIG. 8 when a second housing of a display device according to still another implementation of the present specification is positioned at one position. FIG. 9B is a cross-sectional view taken along line IV-IV′ in FIG. 8 when the second housing of the display device according to still another implementation of the present specification is rotated and positioned at another position.

Because a display device 3000 according to still another implementation of the present specification is substantially identical in configurations to the display device 2000 according to another implementation of the present specification described above with reference to FIGS. 6 to 7B, except for an optical system 300″, a repeated description will be omitted.

With reference to FIGS. 8 and 9A together, the optical system 300′ according to still another implementation of the present specification includes a first part 311″ coupled to the second housing 500, and a second part 312″ positioned below the first part 311″.

The first part 311″ of the optical system 300″ may be a parallax barrier layer including a plurality of unit barriers 311-1 spaced apart from one another at predetermined intervals, and a rim portion 311-2 joined to two opposite ends of each of the unit barriers 311-1. For example, opening portions are provided between the unit barriers 311-1 to expose the pixels P of the display panel 100. The size of the opening portion is set such that the light beams from one subpixel are separated by one unit barrier 311-1. The intervals at which the unit barriers 311-1 are disposed may be set to separate the light beams from the two or more subpixels.

The second part 312″ of the optical system 300″ may be an elastic support part joined to the edge of the parallax barrier layer 311″ and configured to support the parallax barrier layer 311″. For example, as illustrated in FIG. 9A, the elastic support part 312″ may be bonded to a part of a bottom surface of the rim portion 311-2 of the parallax barrier layer 311″. For example, the elastic support part 312″ may include polydimethyl siloxane (PDMS).

The elastic support part 312″ of the optical system 300″ may be disposed on the spacer 200 and accommodated in the first housing 400, and the parallax barrier layer 311″ may be disposed above the elastic support part 312″ when the parallax barrier layer 311″ is coupled to one side of the second housing 500.

With reference to FIG. 9A, the first coupling protrusion 512a and the second coupling protrusion 512b, which are spaced apart from each other at a predetermined interval in the vertical direction, are provided on the support portion 510 of the second housing 500, and a part of the rim portion 311-2 of the parallax barrier layer 311″ is inserted and coupled into the separation space between the first coupling protrusion 512a and the second coupling protrusion 512b provided on the support portion 510 of the second housing 500. That is, the rim portion 311-2 of the parallax barrier layer 311″ is caught by the first coupling protrusion 512a and the second coupling protrusion 512b of the support portion 510 of the second housing 500. In addition, a bottom surface of the elastic support part 312″ is bonded to a top surface of the spacer 200.

The second housing 500 may rotate at least between a first position at which a distance between the parallax barrier layer 311″ and the display panel 100 is a preset first distance and a second position at which a distance between the parallax barrier layer 311″ and the display panel 100 is a preset second distance different from the first distance.

When the second housing 500 rotates between the first position and the second position, the rim portion 311-2 of the parallax barrier layer 311″, which has a bottom surface to which the elastic support part 312″ is bonded, is caught by the first coupling protrusion 512a and the second coupling protrusion 512b provided on the support portion 510 of the second housing 500 and receives a force in the upward/downward direction in the state in which the bottom surface of the elastic support part 312″ is bonded to the spacer 200, such that a height of the elastic support part 312″ changes. Therefore, when the second housing 500 rotates between the first position and the second position, a distance between the parallax barrier layer 311″ and the display panel 100 also changes.

FIG. 9A illustrates a cross-section taken along the line (III-III′) traversing the display device 3000 in the first direction (e.g., the X-axis direction in FIG. 8) in which the observer's two eyes are positioned in case that the second housing 500 is disposed at the first position.

As illustrated in FIG. 9A, in case that the second housing 500 is disposed at the first position, in the first direction (i.e., the X-axis direction), the unit barriers 311-1 of the parallax barrier layer 311″ change the path of the light so that the light outputted from the pixels P of the display panel 100 is provided to the left and right eyes of the observer at the preset first observation distance.

FIG. 9B illustrates a cross-section taken along the line (III-III′) traversing the display device 3000 in the first direction (e.g., the X-axis direction in FIG. 8) in which the observer's two eyes are positioned in case that the second housing 500 is disposed at the second position.

As illustrated in FIG. 9B, in case that the second housing 500 is disposed at the second position, in the first direction (i.e., the X-axis direction), the unit barriers 311-1 of the parallax barrier layer 311″ change the path of the light so that the light outputted from the pixels P of the display panel 100 is provided to the left and right eyes of the observer at the preset second observation distance.

A distance h′ between the parallax barrier layer 311″ and the bottom surface of the elastic support part 312″ when the second housing 500 is disposed at the second position is smaller than a distance h′ between the parallax barrier layer 311″ and the bottom surface of the elastic support part 312″ when the second housing 500 is disposed at the first position. That is, a height of the support portion 312b of the elastic body part 312′ decreases. In addition, as the second housing 500 rotates from the first position to the second position, the distance between the parallax barrier layer 311″ and the display panel 100 gradually decreases.

When the second housing 500 rotates between the first position and the second position, the optical system 300″ changes the path of the light outputted from the display panel 100 so that the path of the light is suitable for the first observation distance and the second observation distance. In this case, the display panel 100 may output images in accordance with three-dimensional image information including an image for the left eye and an image for the right eye.

Therefore, the display panel 100 of the display device 3000 according to still another implementation of the present specification may output the images in accordance with the three-dimensional image information and minimize three-dimensional crosstalk caused by an observation distance of the observer.

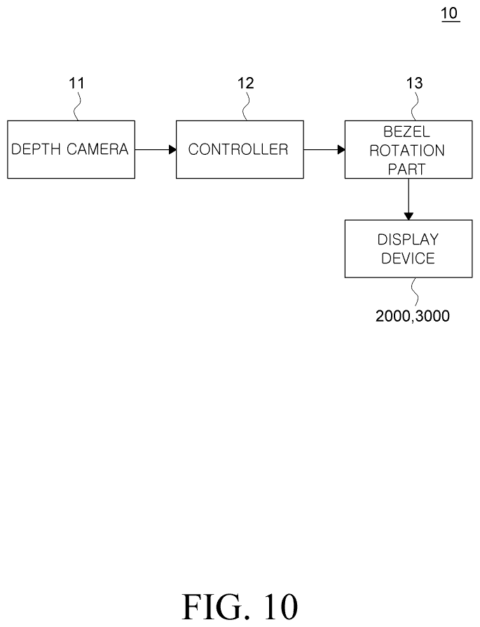

FIG. 10 is a block diagram for explaining a display system according to yet another implementation of the present specification.

With reference to FIG. 10, a display system 10 according to still another implementation of the present specification may include a depth camera 11, a controller 12, a bezel rotation part 13, and the display device 2000 or 3000.

The display system 10 according to yet another implementation of the present specification may include any one of the display device 2000 according to another implementation of the present specification described with reference to FIGS. 6 to 7B and the display device 3000 according to still another implementation of the present specification described with reference to FIGS. 8 to 9B. Therefore, a repeated description of the display device 2000 according to another implementation of the present specification and the display device 3000 according to still another implementation of the present specification will be omitted.

The depth camera 11 detects the positions of the observer's two eyes that observe the display device 2000 or 3000 and provide the controller 12 with information on a distance from the observer's two eyes, i.e., depth information in accordance with the detection result.

The bezel rotation part 13 rotates the second housing 500 of the display device 2000 or 3000 in a rotation direction and at a rotation angle under the control of the controller 12.

On the basis of the depth information on the distance from the observer provided from the depth camera 11, the controller 12 controls the bezel rotation part 13 so that the three-dimensional image outputted from the display panel 100 of the display device 2000 or 3000 is outputted to suit a focal point in accordance with a position of the observer. In this case, the controller 12 controls the bezel rotation part 13 so that the second housing 500 of the display device 2000 or 3000 rotates to a position corresponding to the detection result of the depth camera 11.

As the position of the observer observing the display device 2000 or 3000 becomes distant from the display panel 100, an angle between the axes of the observer's two eyes observing the subpixels of the display panel 100 decreases. Therefore, an angle at which the light beams outputted from the subpixels of the display panel 100 are separated also needs to decrease. Therefore, the controller 12 controls the bezel rotation part 13 so that the distance between the lens array layer 311′ of the display device 2000 and the display panel 100 or the distance between the parallax barrier layer 311″ of the display device 3000 and the display panel 100 increases as the position of the observer observing the display device 2000 or 3000 becomes distant from the display panel 100.

In contrast, as the position of the observer observing the display device 2000 or 3000 becomes close to the display panel 100, the angle between the axes of the observer's two eyes observing the subpixels of the display panel 100 increases. Therefore, the angle at which the light beams outputted from the subpixels of the display panel 100 are separated also needs to increase. Therefore, the controller 12 controls the bezel rotation part 13 so that the distance between the lens array layer 311′ of the display device 2000 and the display panel 100 or the distance between the parallax barrier layer 311″ of the display device 3000 and the display panel 100 decreases as the position of the observer observing the display device 2000 or 3000 becomes close to the display panel 100. For example, in the display device 2000, as the distance between the lens array layer 311′ and the display panel 100 decreases, the center thickness of the convex lens formed by the elastic film 311b increases, and a radius of curvature of the convex lens decreases, such that the focal length decreases.

The pixels of the display panel 100 below the lens array layer 311′ of the display device 2000 or the parallax barrier layer 311″ of the display device 3000 may be divided into two groups, the light from one pixel group may propagate to the left eye of the observer, and the light from the other pixel group may propagate to the right eye of the observer. For example, in order to apply an appropriate focal point in accordance with the observation distance, a condition of “P:g=IPD: d” needs to be satisfied when a radius of the convex lens formed by the elastic film 311b of the lens array layer 311′ of the display device 2000 or an interval between the unit barriers 311-1 of the parallax barrier layer 311″ of the display device 3000 is P, an interval between the observer's two eyes is IPD, a distance (i.e., the observation distance) between the display panel 100 and the observer's two eyes is d, and a distance between the optical system 300′ or 300″ and the display panel 100 is g. Therefore, in order to maintain a proportional equation of “2*arctan ((IPD/2)/d)=2*arctan ((P/2)/g)”, the controller 12 may adjust the distance g between the optical system 300′ or 300″ and the display panel 100 by controlling the bezel rotation part 13.

As described above, the display system 10 according to still another implementation of the present specification may provide the high-quality three-dimensional image with minimized crosstalk by decreasing the interval between the optical system and the display panel when the observation distance of the observer decreases and increasing the interval between the optical system and the display panel when the observation distance increases so that the pixel groups of the display panel 100 appropriately separate the light beams and provide the light beams to the left and right eyes of the observer.

The exemplary implementations of the present disclosure can also be described as follows:

According to an aspect of the present disclosure, there is provided a display device. The display device includes a first housing having therein an accommodation space. The display device further includes a display panel accommodated in the first housing. The display device further includes a second housing rotatably coupled to the first housing above the display panel, and exposing a display area of the display panel when the second housing is coupled to the first housing. The display device further includes an optical system including a first part coupled to the second housing, and a second part positioned below the first part, the optical system changing a path of light outputted from the display panel.

The first part may be a concave lens array layer having a plurality of concave lenses disposed on a surface facing the second part, and the second part may be a convex lens array layer having a plurality of convex lenses disposed on a surface facing the first part.

The second housing may be coupled to the first housing and configured to be rotatable between a first position at which the plurality of concave lenses are parallel to the plurality of convex lenses and a second position at which the plurality of concave lenses are perpendicular to the plurality of convex lenses.

The display panel may display an image in accordance with three-dimensional image information when the second housing is disposed at the second position.

A distance between the convex lens array layer and the concave lens array layer gradually increases as the second housing rotates from the first position to the second position.

When the second housing is disposed at the second position, the display panel may output a three-dimensional image processed by compensating for distortion caused by the distance between the convex lens array layer and the concave lens array layer.

The display panel may display an image in accordance with two-dimensional image information when the second housing is disposed at the first position.

The first part may be a lens array layer including a plurality of partition walls spaced apart from one another at predetermined intervals, and elastic films disposed between the partition walls, and the second part may be an elastic body part including a bottom portion having a predetermined area, and a support portion extending upward from an edge of the bottom portion and joined to an edge of the lens array layer, the elastic body part having an internal space sealed by joining the second part and the lens array layer.

The second housing may be coupled to the first housing and configured to be rotatable between a first position at which a surface of the elastic film is parallel to a top surface of the second housing and a second position at which the surface of the elastic film is divided by the plurality of partition walls to from a plurality of convex lenses each having a maximum center thickness.

When the second housing rotates from the first position to the second position, a first distance between the lens array layer and the display panel and a second distance between the lens array layer and a bottom surface of the elastic body part may gradually decrease, and center thickness of each of the plurality of convex lenses may gradually increases.

The display panel may output an image in accordance with three-dimensional image information when the second housing is disposed at the second position.

The display panel may output an image in accordance with two-dimensional image information when the second housing is disposed at the first position.

Either the elastic film, or the elastic body part, or both the elastic film and the elastic body part may include polydimethyl siloxane (PDMS).

The display device may further include a liquid accommodated in the internal space sealed by the lens array layer and the elastic body part, wherein the liquid is an ethylene glycol aqueous solution.

A height of the support portion may be changed by a rotation of the second housing.

The first part may be a parallax barrier layer including a plurality of unit barriers spaced apart from one another at predetermined intervals, and the second part may be an elastic support part joined to an edge of the parallax barrier layer and configured to support the parallax barrier layer.

The second housing may be coupled to the first housing and configured to be rotatable between a first position at which a distance between the parallax barrier layer and the display panel is a preset first distance and a second position at which a distance between the parallax barrier layer and the display panel is a preset second distance different from the first distance.

A distance between the parallax barrier layer and the display panel may gradually increase or decrease as the second housing rotates from the first position to the second position.

A height of the elastic support part may be changed by a rotation of the second housing.

The display device may further include a spacer provided above the display panel, accommodated in the first housing, and disposed between the display panel and the optical system.

The first housing and the second housing may be screw-coupled.

The second housing may include a bezel including an opening portion through which the display area of the display panel is exposed, and a first support portion extending from the bezel in a downward direction. A screw thread or screw trough configured to be coupled to the first housing may be provided on an outer or inner surface of the first support portion.

The first housing may include a bottom portion having a predetermined area, and a second support portion extending from the bottom portion in an upward direction. A screw trough corresponding to the screw thread of the first support portion or a screw thread corresponding to the screw trough of the first support portion may be provided on an inner or outer surface of the second support portion.

According to another aspect of the present disclosure, there is provided a display system, The display system includes a a first housing having therein an accommodation space. The display system further includes a display panel accommodated in the first housing. The display system further includes a second housing provided above the display panel and rotatably coupled to the first housing, and exposing a display area of the display panel when the second housing is coupled to the first housing. The display system further includes an optical system coupled to the second housing and configured to change a path of light outputted from the display panel. The display system further includes a depth camera configured to detect positions of an observer's two eyes. The display system further includes a bezel rotation part configured to rotate the second housing in a preset direction and at a predetermined angle. The display system further includes a controller configured to control a rotation direction and a rotation angle of the bezel rotation part so that a three-dimensional image, among images outputted from the display panel, is outputted to suit a focal point corresponding to the positions of the observer's two eyes detected by the depth camera.

The optical system may include a lens array layer coupled to the second housing and including a plurality of partition walls spaced apart from one another at predetermined intervals, and elastic films disposed between the partition walls. The optical system may further include an elastic body part positioned below the lens array layer, joined to an edge of the lens array layer, and having an internal space sealed by joining the elastic body part and the lens array layer. The optical system may further include a liquid accommodated in the internal space of the elastic body part.

The second housing may be coupled to the first housing and configured to be rotatable between a first position at which a surface of the elastic film is parallel to a top surface of the second housing and a second position at which the surface of the elastic film is divided by the plurality of partition walls to from a plurality of convex lenses each having a predetermined maximum height. The controller may control the bezel rotation part to rotate the second housing to a position corresponding to a detection result of the depth camera.

The optical system may include a parallax barrier layer coupled to the second housing and including a plurality of unit barriers spaced apart from one another at predetermined intervals, and an elastic support part positioned below the parallax barrier layer, joined to an edge of the parallax barrier layer, and configured to support the parallax barrier layer.

The second housing may be coupled to the first housing and configured to be rotatable between a first position at which a distance between the parallax barrier layer and the display panel is a preset first distance and a second position at which a distance between the parallax barrier layer and the display panel is a preset second distance different from the first distance. The controller may control the bezel rotation part to rotate the second housing to a position corresponding to a detection result of the depth camera.

Although the exemplary implementations of the present disclosure have been described in detail with reference to the accompanying drawings, the present disclosure is not limited thereto and may be embodied in many different forms without departing from the technical concept of the present disclosure. Therefore, the exemplary implementations of the present disclosure are provided for illustrative purposes only but not intended to limit the technical concept of the present disclosure. The scope of the technical concept of the present disclosure is not limited thereto. Therefore, it should be understood that the above-described exemplary implementations are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A display device comprising:
a first housing having therein an accommodation space;
a display panel accommodated in the first housing;
a second housing provided above the display panel and rotatably coupled to the first housing, and exposing a display area of the display panel when the second housing is coupled to the first housing; and
an optical system including a first part coupled to the second housing, and a second part positioned below the first part, the optical system configured to change a path of light outputted from the display panel.

2. The display device of claim 1, wherein the first part is a concave lens array layer having a plurality of concave lenses disposed on a surface facing the second part, and the second part is a convex lens array layer having a plurality of convex lenses disposed on a surface facing the first part.

3. The display device of claim 2, wherein the second housing is coupled to the first housing and configured to be rotatable between a first position at which the plurality of concave lenses are parallel to the plurality of convex lenses and a second position at which the plurality of concave lenses are perpendicular to the plurality of convex lenses,
herein the display panel displays an image in accordance with three-dimensional image information when the second housing is disposed at the second position,
herein a distance between the convex lens array layer and the concave lens array layer gradually increases as the second housing rotates from the first position to the second position,
herein when the second housing is disposed at the second position, the display panel outputs a three-dimensional image processed by compensating for distortion caused by the distance between the convex lens array layer and the concave lens array layer.

4. The display device of claim 3, wherein the display panel displays an image in accordance with two-dimensional image information when the second housing is disposed at the first position.

5. The display device of claim 1, wherein the first part is a lens array layer including a plurality of partition walls spaced apart from one another at predetermined intervals, and elastic films disposed between the partition walls, and the second part is an elastic body part including a bottom portion having a predetermined area, and a support portion extending upward from an edge of the bottom portion and joined to an edge of the lens array layer, the elastic body part having an internal space sealed by joining the second part and the lens array layer.

6. The display device of claim 5, wherein the second housing is coupled to the first housing and configured to be rotatable between a first position at which a surface of an elastic film is parallel to a top surface of the second housing and a second position at which the surface of the elastic film is divided by the plurality of partition walls to form a plurality of convex lenses each having a maximum center thickness,
herein when the second housing rotates from the first position to the second position, a first distance between the lens array layer and the display panel and a second distance between the lens array layer and a bottom surface of the elastic body part gradually decrease, and center thickness of each of the plurality of convex lenses gradually increases,
herein the display panel outputs an image in accordance with three-dimensional image information when the second housing is disposed at the second position, and
herein the display panel outputs an image in accordance with two-dimensional image information when the second housing is disposed at the first position.

7. The display device of claim 5, wherein either the elastic film, or the elastic body part, or both the elastic film and the elastic body part include polydimethyl siloxane (PDMS).

8. The display device of claim 5, further comprising:
a liquid accommodated in the internal space sealed by the lens array layer and the elastic body part, wherein the liquid is an ethylene glycol aqueous solution.

9. The display device of claim 6, wherein a height of the support portion is changed by a rotation of the second housing.

10. The display device of claim 1, wherein the first part is a parallax barrier layer including a plurality of unit barriers spaced apart from one another at predetermined intervals, and the second part is an elastic support part joined to an edge of the parallax barrier layer and configured to support the parallax barrier layer.

1. The display device of claim 10, wherein the second housing is coupled to the first housing and configured to be rotatable between a first position at which a distance between the parallax barrier layer and the display panel is a preset first distance and a second position at which a distance between the parallax barrier layer and the display panel is a preset second distance different from the preset first distance,
herein a distance between the parallax barrier layer and the display panel gradually increases or decreases as the second housing rotates from the first position to the second position, and
herein a height of the elastic support part is changed by a rotation of the second housing.

12. The display device of claim 1, further comprising:
a spacer provided above the display panel, accommodated in the first housing, and disposed between the display panel and the optical system.

13. The display device of claim 1, wherein the first housing and the second housing are screw-coupled.

14. The display device of claim 13, wherein the second housing includes:
a bezel including an opening portion through which the display area of the display panel is exposed; and
a first support portion extending from the bezel in a downward direction, and
wherein a screw thread or screw trough configured to be coupled to the first housing is provided on an outer or inner surface of the first support portion.

15. The display device of claim 14, wherein the first housing includes:
a bottom portion having a predetermined area; and
a second support portion extending from the bottom portion in an upward direction, and
wherein a screw trough corresponding to the screw thread of the first support portion or a screw thread corresponding to the screw trough of the first support portion is provided on an inner or outer surface of the second support portion.

16. A display system comprising:
a first housing having therein an accommodation space;
a display panel accommodated in the first housing;
a second housing provided above the display panel and rotatably coupled to the first housing, and exposing a display area of the display panel when the second housing is coupled to the first housing;
an optical system coupled to the second housing and configured to change a path of light outputted from the display panel;
a depth camera configured to detect positions of an observer's two eyes;
a bezel rotation part configured to rotate the second housing in a preset direction and at a predetermined angle; and
a controller configured to control a rotation direction and a rotation angle of the bezel rotation part so that a three-dimensional image, among images outputted from the display panel, is outputted to suit a focal point corresponding to the positions of the observer's two eyes detected by the depth camera.

17. The display system of claim 16, wherein the optical system includes:
a lens array layer coupled to the second housing and including a plurality of partition walls spaced apart from one another at predetermined intervals, and elastic films disposed between the partition walls;
an elastic body part positioned below the lens array layer, joined to an edge of the lens array layer, and having an internal space sealed by joining the elastic body part and the lens array layer; and
a liquid accommodated in the internal space of the elastic body part.

18. The display system of claim 17, wherein the second housing is coupled to the first housing and configured to be rotatable between a first position at which a surface of an elastic film is parallel to a top surface of the second housing and a second position at which the surface of the elastic film is divided by the plurality of partition walls to form a plurality of convex lenses each having a predetermined maximum height, and
wherein the controller controls the bezel rotation part to rotate the second housing to a position corresponding to a detection result of the depth camera.

19. The display system of claim 16, wherein the optical system includes:
a parallax barrier layer coupled to the second housing and including a plurality of unit barriers spaced apart from one another at predetermined intervals; and
an elastic support part positioned below the parallax barrier layer, joined to an edge of the parallax barrier layer, and configured to support the parallax barrier layer.

20. The display system of claim 19, wherein the second housing is coupled to the first housing and configured to be rotatable between a first position at which a distance between the parallax barrier layer and the display panel is a preset first distance and a second position at which a distance between the parallax barrier layer and the display panel is a preset second distance different from the preset first distance, and
wherein the controller controls the bezel rotation part to rotate the second housing to a position corresponding to a detection result of the depth camera.
